(19) United States
(12) Patent Application Publication
(10) Pub. No.: US 2024/0080119 A1
(43) Pub. Date: Mar. 7, 2024

(54) INFORMATION PROCESSING APPARATUS, SYSTEM, METHOD, AND STORAGE MEDIUM

(71) Applicant: KABUSHIKI KAISHA TOSHIBA, Tokyo (JP)

(72) Inventors: Daisuke UCHIDA, Kawasaki Kanagawa (JP); Tomoya TANDAI, Ota Tokyo (JP); Koji AKITA, Kawasaki Kanagawa (JP)

(73) Assignee: KABUSHIKI KAISHA TOSHIBA, Tokyo (JP)

(21) Appl. No.: 18/183,363

(22) Filed: Mar. 14, 2023

(30) Foreign Application Priority Data
Sep. 2, 2022 (JP) 2022-140027

(51) Int. Cl. H04B 17/391; G08G 1/0967; H04B 17/327; H04W 4/02; H04W 4/44; H04W 24/02; H04W 24/04; H04W 24/08; H04W 64/00

(52) U.S. Cl. CPC H04B 17/391; G08G 1/096725; G08G 1/096783; H04B 17/327; H04W 4/023; H04W 4/025; H04W 4/44; H04W 24/02; H04W 24/04; H04W 24/08; H04W 64/00

(57) ABSTRACT

According to one embodiment, an information processing apparatus includes a processing circuit configured to acquire first data that includes a first position of a mobile object at a time of receiving a first signal from an antenna or a first distance between the mobile object and the antenna, and a first received power of the first signal, acquire second data that includes a second position of the mobile object at a time of receiving a second signal from the antenna or a second distance between the mobile object and the antenna, and a second received power of the second signal, and estimate a propagation environment of a signal in a space facing the antenna with the second position interposed therebetween by comparing the first data with the second data.

### CROSS-REFERENCE TO RELATED APPLICATIONS

This application is based upon and claims the benefit of priority from Japanese Patent Application No. 2022-140027, filed Sep. 2, 2022, the entire contents of which are incorporated herein by reference.

### FIELD

Embodiments described herein relate generally to an information processing apparatus, a system, a method, and a storage medium.

### BACKGROUND

In recent years, it is known to control a mobile object (for example, a mobile robot or the like) moving in a predetermined space by executing, for example, wireless communication. In this case, for example, the mobile object is controlled to move along a route from a start point to a goal point set on a map of a space in which the mobile object moves.

Incidentally, although a control signal for controlling the mobile object is transmitted as a radio wave from an antenna, in a case where an obstacle (radio wave shielding object) is disposed in a space in which the mobile object moves, there is a possibility that a propagation environment of a signal in a space (that is, a space on a far side of the obstacle as viewed from the antenna) facing the antenna with the obstacle interposed therebetween deteriorates (that is, a radio quiet zone in which a received power decreases is generated) by the obstacle. In such a case, a route that avoids the radio quiet zone can be selected.

Here, since the signal propagation environment in the radio quiet zone is improved (recovered) in a case where the above-described obstacle is removed, the mobile object does not need to move while the radio quiet zone is avoided.

However, it is difficult to efficiently grasp the propagation environment (that is, the propagation environment of the signal in the radio quiet zone is improved) of the signal in the space in which the mobile object moves.

### BRIEF DESCRIPTION OF THE DRAWINGS

FIG. 1 is a diagram illustrating an example of a local 5G system applied to an embodiment.

FIG. 2 is a diagram illustrating an example of a map of a target space.

FIG. 3 is a diagram for describing an example of an environment assumed in the present embodiment.

FIG. 4 is a diagram illustrating an example of a functional configuration of a mobile object.

FIG. 5 is a diagram illustrating an example of a functional configuration of an information processing apparatus.

FIG. 6 is a diagram illustrating an example of a system configuration of the information processing apparatus.

FIG. 7 is a diagram illustrating an example of a processing procedure of the information processing apparatus.

FIG. 8 is a diagram for describing a principle of estimating a propagation environment of a signal in an estimation target zone.

FIG. 9 is a diagram for describing the principle of estimating the propagation environment of the signal in the estimation target zone.

FIG. 10 is a diagram for describing the principle of estimating the propagation environment of the signal in the estimation target zone.

FIG. 11 is a diagram for describing the principle of estimating the propagation environment of the signal in the estimation target zone.

FIG. 12 is a diagram for describing the principle of estimating the propagation environment of the signal in the estimation target zone.

FIG. 13 is a diagram for describing the principle of estimating the propagation environment of the signal in the estimation target zone.

### DETAILED DESCRIPTION

In general, according to one embodiment, an information processing apparatus includes a processing circuit. The processing circuit is configured to acquire first data that includes a first position of a mobile object at a time of receiving a first signal transmitted from an antenna or a first distance between the mobile object and the antenna, and a first received power of the first signal, acquire second data that includes a second position of the mobile object at a time of receiving a second signal different from the first signal transmitted from the antenna or a second distance between the mobile object and the antenna, and a second received power of the second signal, and estimate a propagation environment of a signal in a space facing the antenna with the second position interposed therebetween by comparing the first data with the second data.

Various embodiments will be described with reference to the accompanying drawings.

An information processing apparatus according to the present embodiment is used to control a mobile object (mobile robot) that moves in a predetermined space (hereinafter, referred to as a target space) such as a factory.

Hereinafter, a scenario to which the information processing apparatus according to the present embodiment is applied will be described. In a case where the mobile object moves on a straight line along a passage disposed in the target space, the control for the mobile object may be simple. However, for example, in a case where an operation of bending a curve or avoiding an obstacle is required for the mobile object, more advanced control is required.

Incidentally, in a case where such control for the mobile object is performed by wire (that is, a control signal for controlling the mobile object is transmitted by wire), there are problems that a range in which the mobile object can move is limited, control of the mobile object becomes impossible due to disconnection, and a wiring work is complicated. In particular, in a case where a large number of mobile objects move in the target space, these problems become remarkable.

By contrast, in a case where the control for the mobile object is wirelessly performed (that is, the mobile object is wirelessly controlled), the above-described problems can be solved. For example, local 5G can be used for such wireless control for the mobile object. The local 5G is, for example, a 5G network that can be individually used by a company or the like, and is useful in an environment in which a large number of mobile objects moving in the target space are wirelessly controlled since it is possible to realize a high speed, a low delay, and multiple simultaneous connections. Note that a wireless LAN can also be used for the wireless control for the mobile object.

Here, the above-described mobile object can be roughly divided into a mobile object that autonomously operates and a mobile object that operates based on a command (control signal) from the outside. Although the mobile object that autonomously operates is useful since each mobile object can operate by discriminating a situation, cost is high, and it is difficult to apply the mobile object to a case where a large number of mobile objects are arranged in the target space. By contrast, in the case of the mobile object that operates based on the command from the outside, it is possible to reduce the total cost of the system including the mobile object and the information processing apparatus by integrating functions of controlling a large number of mobile bodies into one apparatus (for example, the information processing apparatus). In addition, since it is possible to collectively manage pieces of information on a large number of mobile objects moving in the space, it is relatively easy to manage the mobile objects.

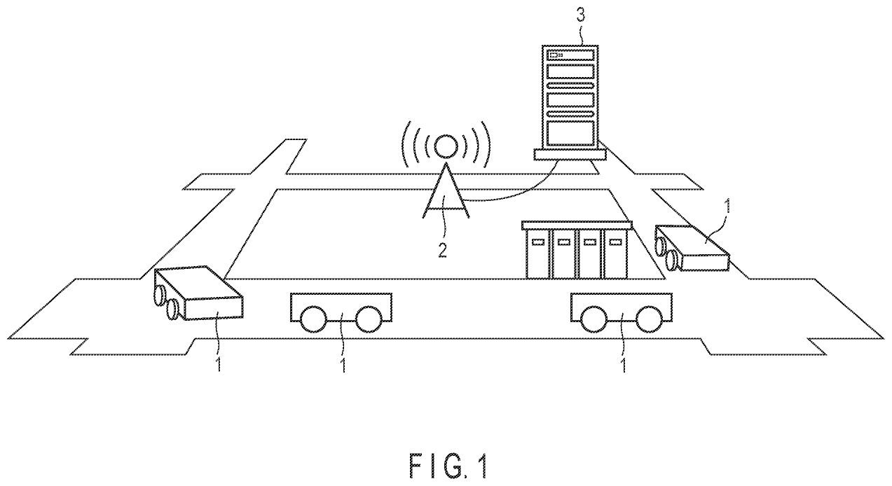

Hereinafter, as illustrated in FIG. 1, it is assumed that a local 5G system (cellular system) that performs terminal-side control on a base station side is applied to the present embodiment.

In the example illustrated in FIG. 1, a situation in which a plurality of mobile objects 1 move in a target space is assumed. Each of the plurality of mobile objects 1 is equipped with a radio device and is connected to a base station 2 to be able to communicate. In addition, an information processing apparatus 3 is connected to the base station 2, and a control signal for controlling the mobile object 1 generated by the information processing apparatus 3 is transmitted from (an antenna installed in) the base station 2 to the mobile object 1. That is, it can be said that the mobile object 1 is connected to the information processing apparatus 3 to be able to communicate via the base station 2. As a result, the mobile object 1 can move in the target space based on the control signal generated in the information processing apparatus 3.

Note that, in FIG. 1, it is assumed that the mobile object 1 is, for example, an autonomous mobile robot (AMR) and the information processing apparatus 3 is, for example, a server apparatus (MEC) called multi-access edge computing. The information processing apparatus 3 may be a server apparatus that provides a cloud computing service.

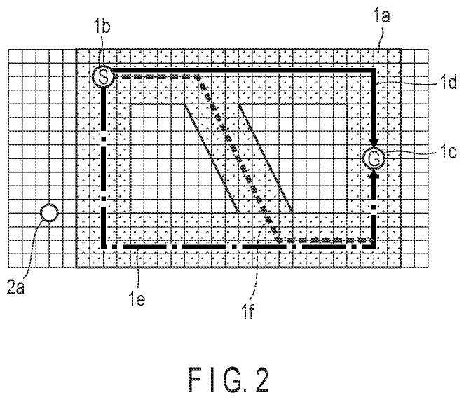

Here, it is assumed that the mobile object 1 is controlled to move in the target space based on (map data indicating) a map of the target space illustrated in FIG. 2. Here, for example, in order to carry a package such as a cardboard box, a situation in which the mobile object 1 moves from a start point 1b set on the map to a goal point 1c along a passage (for example, a traveling path provided in a factory) la shown on the map is considered.

In this case, as a route for moving from the start point 1b to the goal point 1c, there are a route 1d corresponding to a shortest route, a route 1e corresponding to a longest route, and a route 1f corresponding to an intermediate route with respect to the shortest route and the longest route.

According to the map illustrated in FIG. 2 described above, the route 1d (that is, the shortest route) is selected from among the routes 1d to 1f, and thus, it is possible to control the mobile object 1 to efficiently move from the start point 1b to the goal point 1c. Note that the control signal for controlling the mobile object 1 in this manner is transmitted from, for example, an antenna 2a installed in the base station 2 to the mobile object 1. Note that the antenna 2a is disposed, for example, in the target space.

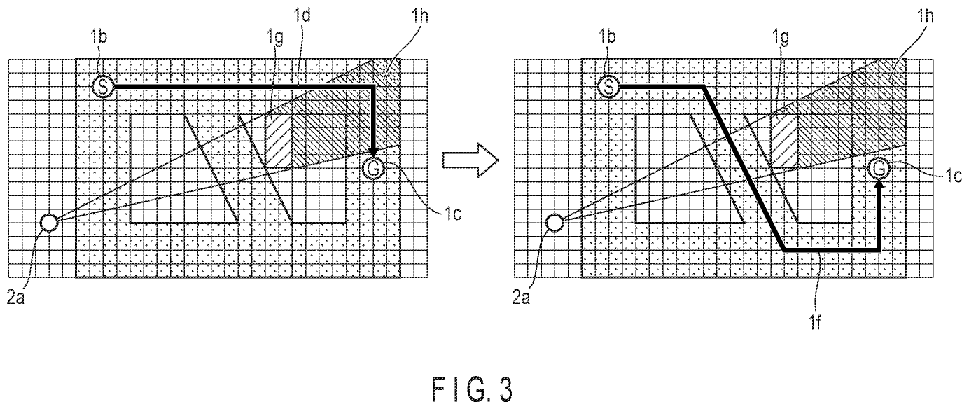

Here, in a case where the target space in which the mobile object 1 moves is, for example, a factory or the like, it is assumed that the arrangement of obstacles (such as cardboard boxes carried by the mobile object 1) in the target space changes with the lapse of time. Here, for example, in a situation in which the mobile object 1 repeatedly carries the package from the start point 1b to the goal point 1c illustrated in FIG. 2 (that is, the plurality of mobile objects 1 sequentially move along a determined route), it is assumed that an obstacle 1g is disposed in the target space as illustrated on a left side of FIG. 3.

In a case where the obstacle 1g is, for example, an object that shields radio waves (that is, for example, is a cardboard box or the like in which a radio wave shielding object is packed), since a signal transmitted from the antenna 2a is shielded by the obstacle 1g, a propagation environment of the signal in a space 1h facing the antenna 2a across the obstacle 1g deteriorates (that is, a radio quiet zone 1h in which a received power decreases is generated).

In the example illustrated in FIG. 3, since the space (that is, the radio quiet zone) 1h in which the propagation environment deteriorates overlaps with the route 1d, in a case where the mobile object 1 moves along the route 1d, there is a possibility that the mobile object 1 cannot normally receive the control signal in the radio quiet zone 1h. That is, the obstacle 1g disposed in the target space as described above becomes a factor that hinders efficient movement (control) of the mobile object 1.

In a case where the radio quiet zone 1h is generated in this manner, for example, the route 1d is changed to the route 1f (intermediate route) as illustrated on a right side of FIG. 3, the mobile object 1 can be controlled to avoid the radio quiet zone 1h.

Incidentally, in a situation in which the plurality of mobile objects 1 repeatedly carry packages along the route 1f changed from the route 1d (that is, the plurality of mobile objects 1 repeatedly move between the start point 1b and the goal point 1c), in a case where the obstacle 1g disposed in the target space is removed with the lapse of time, (the deterioration of) the propagation environment of the signal in the radio quiet zone 1h is improved, and the radio quiet zone 1h is eliminated. In this case, it is preferable to grasp the elimination of the radio quiet zone 1h and change the route along which the mobile object 1 moves from the route 1f to the route 1d again (that is, the route 1d is selected again as an appropriate route of the mobile object 1).

Here, a method for grasping the elimination of the radio quiet zone 1h in a comparative example of the present embodiment will be described.

First, the mobile object 1 is controlled to move along the route 1d at an any timing when the mobile object 1 repeatedly carries packages along the route 1f, and a synchronization signal is transmitted from the antenna 2a (base station 2) when the mobile object 1 passes through the radio quiet zone 1h. The mobile object 1 measures a received power of the synchronization signal by receiving the synchronization signal transmitted from the antenna 2a.

In the comparative example of the present embodiment, when the received power measured in the radio quiet zone 1h is equal to or more than a threshold as described above, it is possible to grasp that the radio quiet zone 1h is eliminated (that is, the propagation environment of the signal in the radio quiet zone 1h is improved). Meanwhile, when the received power measured in the radio quiet zone 1h is less than the threshold, it can be grasped that the radio quiet zone 1h is not eliminated.

However, in a case where the mobile object 1 is moved to the radio quiet zone 1h in a state where the radio quiet zone 1h is not eliminated (that is, the obstacle 1g is not removed), there is a possibility that the mobile object 1 cannot appropriately receive the control signal in the radio quiet zone 1h and does not normally operate (for example, an operation is stopped). In this case, it takes a time to restart a normal operation of the mobile object 1, and it cannot be said that the elimination of the radio quiet zone 1h can be efficiently grasped. Furthermore, moving in the radio quiet zone 1h may cause an accident or the like due to the inability to appropriately receive the control signal (that is, an instruction to change a moving speed and a moving direction, and the like).

In addition, for example, it is considered that the presence or absence of the obstacle 1g is directly detected without moving the mobile object 1 to the above-described radio quiet zone 1h by using the reflection of a laser emitted from the mobile object 1.

However, in the situation in which the mobile object 1 moves in the target space such as a factory as described above, for example, the obstacle 1g in which a plurality of cardboard boxes for packing radio wave shielding objects are stacked (that is, loaded) in a height direction may be disposed, and a height of the obstacle 1g changes when the cardboard boxes are removed or further stacked. It is considered that the propagation environment of the signal depends on such a height of the obstacle 1g. Specifically, even though the obstacle 1g is disposed at the position illustrated in FIG. 3, in a case where the height of the obstacle 1g is low (the number of cardboard boxes stacked in the height direction is small), there is a possibility that the radio quiet zone 1h is eliminated.

By contrast, according to the straightness of the laser emitted from the mobile object 1 as described above, it is difficult to grasp the height direction of the obstacle 1g, and it is not possible to grasp the elimination of the radio quiet zone 1h in consideration of the height direction of the obstacle 1g. Although it is considered that a mechanism capable of grasping the height direction is applied, in a case where the plurality of mobile objects 1 are controlled, the cost of constructing the system increases.

Furthermore, in a case where the obstacle 1g that is a radio wave shielding object is replaced with an obstacle that is not a radio wave shielding object, the radio quiet zone 1h may be eliminated even though the obstacle is disposed.

That is, even though the presence or absence of the obstacle is detected by using the reflection of the laser emitted from the mobile object 1, it may not be possible to appropriately grasp the elimination of the radio quiet zone 1h based on the detection result.

Thus, in the present embodiment, a mobile object control system capable of estimating (analogizing) the propagation environment of the signal in the target zone (space) such as the radio quiet zone while a situation in which the mobile object 1 cannot normally operate is avoided will be described. As illustrated in FIG. 1 described above, the mobile object control system according to the present embodiment includes the mobile object 1 (for example, AMR) and the information processing apparatus 3 (for example, MEC) connected to the mobile object 1 to be able to communicate via the base station 2.

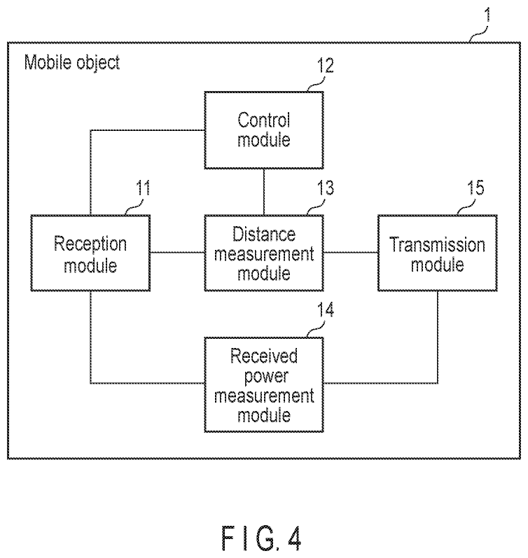

First, an example of a functional configuration of the mobile object 1 will be described with reference to FIG. 4. As illustrated in FIG. 4, the mobile object 1 includes a reception module 11, a control module 12, a distance measurement module 13, a received power measurement module 14, and a transmission module 15.

The reception module 11 receives a control signal for controlling the mobile object 1. The control signal received by the reception module 11 is output to the control module 12. In addition, the reception module 11 receives a synchronization signal for measuring a received power to be described later. The control signal received by the reception module 11 is output to the received power measurement module 14. Note that the control signal and the synchronization signal are transmitted from the antenna installed in the base station 2 to the mobile object 1.

The control module 12 controls the mobile object 1 based on the control signal output from the reception module 11. The mobile object 1 includes wheels or the like for moving the mobile object 1, and the control module 12 moves the mobile object 1 by controlling a rotation speed and a direction (that is, a moving speed and a direction of the mobile object 1) of the wheels according to the control signal. The moving speed and the direction of the mobile object 1 controlled by the control module 12 are output to the distance measurement module 13.

The distance measurement module 13 is realized by, for example, an optical distance sensor (LRF: Laser Range Finder) or the like, and measures a distance from the mobile object 1 to a wall or an obstacle present around the mobile object 1 based on a time (TOF: Time Of Flight) until laser (light) emitted from the LRF is reflected. (LRF scan data indicating) the distance measured by the distance measurement module 13 and (data indicating) the moving speed and the direction of the mobile object 1 output from the control module 12 in this manner are output as data (hereinafter, referred to as map creation data) for creating map data to be described later to the transmission module 15.

The received power measurement module 14 measures the received power (power intensity) of the synchronization signal based on the synchronization signal output from the reception module 11. Received power data indicating the received power measured by the received power measurement module 14 is transmitted to the transmission module 15.

The transmission module 15 transmits the map creation data output from the distance measurement module 13 to the information processing apparatus 3. In addition, the transmission module 15 transmits the received power data output from the received power measurement module 14 to the information processing apparatus 3.

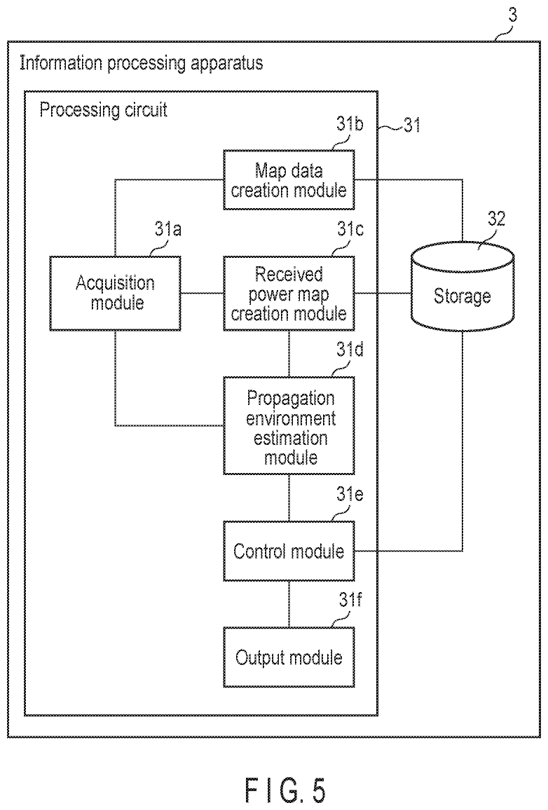

Next, an example of a functional configuration of the information processing apparatus 3 will be described with reference to FIG. 5. Note that the information processing apparatus (MEC) 3 according to the present embodiment is configured to acquire data from the mobile object 1 side via (the antenna installed in) the above-described base station 2 and instruct the mobile object 1 on a route (travel route) along which the mobile object 1 moves.

As illustrated in FIG. 5, the information processing apparatus 3 includes a processing circuit 31 and storage 32. In addition, the processing circuit 31 includes an acquisition module 31a, a map data creation module 31b, a received power map creation module 31c, a propagation environment estimation module 31d, a control module 31e, and an output module 31f.

The map creation data and the received power data transmitted by the transmission module 15 included in the above-described mobile object 1 are received by the antenna installed in the base station 2. The acquisition module 31a acquires the map creation data and the received power data received by the antenna from the base station 2. The map creation data acquired by the acquisition module 31a is output to the map data creation module 31b, the received power map creation module 31c, and the propagation environment estimation module 31d, and the received power data acquired by the acquisition module 31a is output to the received power map creation module 31c and the propagation environment estimation module 31d.

The map data creation module 31b creates map data indicating a map of the target space based on the map creation data output from the acquisition module 31a. The map data created by the map data creation module 31b is stored in the storage 32.

The received power map creation module 31c creates a received power map of the target space based on the map creation data and the received power data output from the acquisition module 31a. The received power map created by the received power map creation module 31c is stored in the storage 32.

The propagation environment estimation module 31d estimates (a change in) the propagation environment of the signal transmitted from the antenna installed in the above-described base station 2 based on the map creation data and the received power data output from the acquisition module 31a. In this case, the propagation environment estimation module 31d estimates a propagation environment of a signal in a space (hereinafter, referred to as an estimation target zone) facing the antenna 2a with the mobile object 1 interposed therebetween, instead of a space in the vicinity of the mobile object 1 moving along a predetermined route. Note that the estimation target zone (the space in which the propagation environment of the signal is estimated) in the present embodiment includes, for example, a space in which the received power of the signal is smaller than the predetermined received power (that is, a space corresponding to the radio quiet zone).

The control module 31e generates the control signal for controlling the mobile object 1 based on the map data and the received power map stored in the storage 32 and the estimation result of the propagation environment by the propagation environment estimation module 31d. The control signal generated by the control module 31e is output to the output module 31f.

The output module 31f outputs the control signal output from the control module 31e to the base station 2. The control signal output from the output module 31f in this manner is transmitted from the antenna installed in the base station 2 to the mobile object 1.

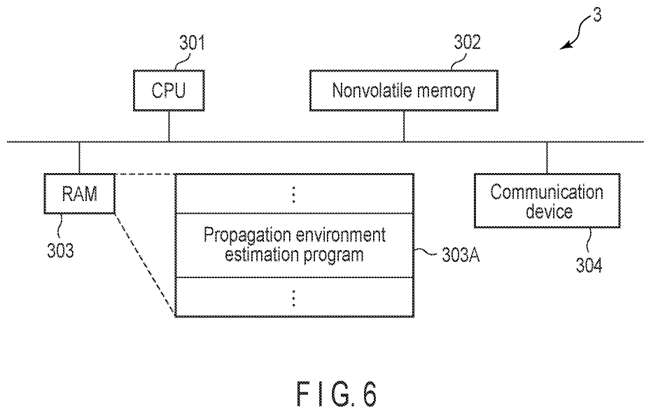

FIG. 6 illustrates an example of a system configuration of the information processing apparatus 3 illustrated in FIG. 5. The information processing apparatus 3 includes a CPU 301, a nonvolatile memory 302, a RAM 303, a communication device 304, and the like.

The CPU 301 is a processor for controlling operations of various components in the information processing apparatus 3. The CPU 301 may include a single processor or may include a plurality of processors. The CPU 301 executes various programs loaded from the nonvolatile memory 302 to the RAM 303. These programs include various application programs including an operating system (OS) and a propagation environment estimation program 303A.

The nonvolatile memory 302 is a storage medium used as an auxiliary storage apparatus. The RAM 303 is a storage medium used as a main storage apparatus. Although only the nonvolatile memory 302 and the RAM 303 are illustrated in FIG. 6, the information processing apparatus 3 may include other storage apparatuses such as a hard disk drive (HDD) and a solid state drive (SSD).

The communication device 304 is a device configured to execute wired communication or wireless communication. Although it is assumed that the information processing apparatus 3 according to the present embodiment is connected to the above-described base station 2 by wire (cable), the information processing apparatus may be connected to the base station 2 to execute wireless communication via a network.

Note that, in the present embodiment, the processing circuit 31 illustrated in FIG. 5 is realized by at least one processor. The processor includes, for example, a control apparatus and an arithmetic apparatus, and is realized by an analog or digital circuit or the like. The processor may be the above-described CPU 301, or may be a general-purpose processor, a microprocessor, a digital signal processor (DSP), an ASIC, an FPGA, or a combination thereof.

Note that the processing circuit 31 can be realized in whole or in part by causing the CPU 301 (that is, a computer of the information processing apparatus 3) to execute the propagation environment estimation program 303A, that is, by software. The propagation environment estimation program 303A may be distributed in a state of being stored in a computer-readable storage medium, or may be downloaded to the information processing apparatus 3 via a network. Note that the processing circuit 31 may be realized in whole or in part by dedicated hardware or the like.

In addition, in the present embodiment, the storage 32 illustrated in FIG. 5 is realized by, for example, the nonvolatile memory 302 or another storage apparatus.

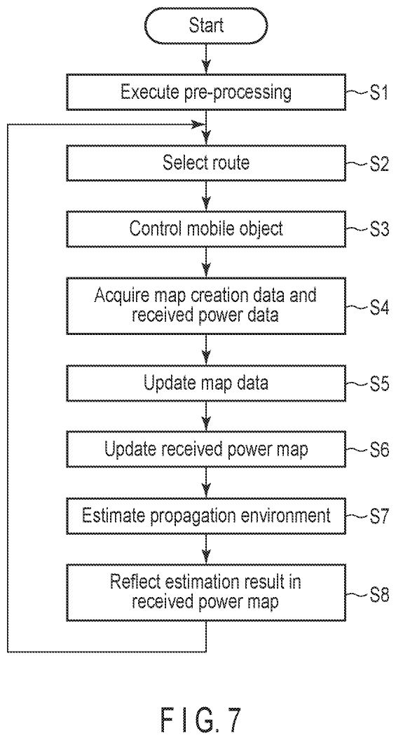

Hereinafter, an example of a processing procedure of the information processing apparatus 3 according to the present embodiment will be described with reference to a flowchart of FIG. 7.

In the information processing apparatus 3 according to the present embodiment, processing of creating the map data and the received power map is executed as pre-processing (preparation) for controlling the mobile object 1 (step S1).

First, processing of the creating map data will be described. In a case where the target space (environment) is a static space to some extent, fixed map data indicating the map of the target space may be prepared in advance, but in the above-described target space such as the factory, the arrangement of obstacles (packages or the like) changes with time, and thus, it is necessary to dynamically create (update) the map data.

In this case, the processing circuit 31 (control module 31e) included in the information processing apparatus 3 generates the control signal for controlling the mobile object 1 to move in the entire range in which the mobile object 1 can move in the target space. The control signal (downlink) generated in the processing circuit 31 in this manner is output from the processing circuit 31 (output module 31f) to the base station 2, and is transmitted from the antenna installed in the base station 2 to the mobile object 1. In this case, the control signal is received by the reception module 11 included in the mobile object 1, and the control module 12 controls the moving speed and the direction of the mobile object 1 based on the control signal. As a result, the entire mobile object 1 moves in the target space.

Here, the distance measurement module 13 included in the mobile object 1 measures the distance to the object (for example, a wall, an obstacle, and the like) present around the mobile object 1 moving in the target space by measuring the TOF by the LRF or the like.

The transmission module 15 transmits the map creation data (uplink) including the distance measured by the distance measurement module 13 and the moving speed and the direction of the mobile object 1 controlled by the control module 12 to the information processing apparatus 3 via (the antenna installed in) the base station 2. Note that the map creation data is transmitted to the information processing apparatus 3 whenever the mobile object 1 moves based on, for example, the control signal (that is, for each point in the target space).

As described above, the map creation data transmitted from the mobile object 1 (transmission module 15) is received by the antenna installed in the base station 2 and is output to the information processing apparatus 3. The processing circuit 31 (acquisition module 31a) included in the information processing apparatus 3 acquires the map creation data output from the base station 2. The processing circuit 31 (map data creation module 31b) creates the map data indicating the map of the target space based on the distance, the moving speed and the direction included in the acquired map creation data of the mobile object 1. The map data created by the processing circuit 31 in this manner is the data indicating the map such as the plan view representing the wall forming the target space, the passage through which the mobile object 1 can move, the obstacle disposed in the target space, and the like.

Note that the map data may be created, for example, by updating an initial layout (map data representing only walls and passages) of the target space in which the obstacle or the like is not disposed.

The map data created by the processing circuit 31 (map data creation module 31b) as described above is stored in the storage 32.

Next, processing of creating the received power map will be described. In this case, the processing circuit 31 (control module 31e) included in the information processing apparatus 3 generates the control signal for controlling the mobile object 1 to move the entire range in which the mobile object 1 can move in the target space based on the map indicated by the map data stored in the storage 32 as described above. The control signal generated in the processing circuit 31 in this manner is output from the processing circuit 31 (output module 31f) to the base station 2 and is transmitted from the antenna installed in the base station 2 to the mobile object 1. As a result, the entire mobile object 1 moves in the target space.

Here, in the 5G (local 5G), the synchronization signal is broadcasted from (the antenna installed in) the base station 2. The reception module 11 included in the mobile object 1 receives the synchronization signal broadcasted from the base station 2 in this manner.

The received power measurement module 14 measures the received power of the synchronization signal received by the reception module 11. Note that the received power measured in the present embodiment may be, for example, at least one of received signal strength indicator (RSSI), reference signal received power (RSRP), secondary synchronization signal-reference signal received power (SSS-RSRP), and primary synchronization signal-reference signal received power (PSS-RSRP).

In addition, here, although it has been described that the received power of the synchronization signal broadcasted from the base station 2 is measured, for example, in the 5G (local 5G), a plurality of reference signals such as a channel state information-reference signal (CSI-RS) which is a reference signal for channel information estimation and a demodulation reference signal (DM-RS) which is a reference signal for demodulation are prepared. Thus, the received power may be measured by using these reference signals. In this case, the received power of one reference signal among the plurality of reference signals having different at least one of a frequency, a time, and an antenna may be measured, or an average value of the received powers of the plurality of reference signals may be measured.

The transmission module 15 transmits the received power data indicating the received power measured by the received power measurement module 14 in this manner to the information processing apparatus 3 via (the antenna installed in) the base station 2. Note that the received power data is transmitted to the information processing apparatus 3, for example, whenever the mobile object 1 moves based on the control signal (for each point in the target space).

Furthermore, although detailed description is omitted here, the above-described map creation data (distance to the object present around the mobile object 1, and the moving speed and the direction of the mobile object 1) is transmitted from the mobile object 1 to the information processing apparatus 3 whenever the mobile object 1 also moves in the processing of creating the received power map.

As described above, the map creation data and the received power data transmitted from the mobile object 1 (transmission module 15) are received by the antenna installed in the base station 2 and are output to the information processing apparatus 3. The processing circuit 31 (acquisition module 31a) included in the information processing apparatus 3 acquires the map creation data and the received power data output from the base station 2.

Here, the processing circuit 31 can acquire (grasp) the position of the mobile object 1 on the map indicated by the map data based on the distance to the object present around the mobile object 1 included in the map creation data, and the moving speed and the direction of the mobile object 1. The processing circuit 31 (received power map creation module 31c) creates the received power map obtained by mapping the position of the mobile object and the received power indicated by the received power data acquired in this manner. Specifically, the processing circuit 31 creates the received power map (radio wave map indicating the propagation environment of the radio wave in the target space) by allocating (that is, the position and the received power are associated with each other) the received power measured at each position of the mobile object 1 to the position.

The received power map created by the processing circuit 31 (received power map creation module 31c) as described above is stored in the storage 32.

Note that, in the processing of creating the received power map, the map creation data is used to acquire the position to which the received power indicated by the received power data is allocated, but the map creation data may be further used to update the map data (that is, arrangement of obstacles, and the like) stored in the above-described storage 32. Here, although the processing of creating the map data and the processing of creating the received power map have been described separately (that is, it has been described that the received power map is created after the map data is created), the map data and the received power map may be created simultaneously (in parallel).

Furthermore, in the present embodiment, when the propagation environment of the signal (radio wave) in the target space can be grasped, a map in which a throughput and a bit error rate of the signal are allocated to each position on the map may be created instead of the received power map.

When the processing of step S1 is executed, the processing circuit 31 (control module 31e) included in the information processing apparatus 3 selects the route along which the mobile object 1 moves in the target space based on the map data and the received power map stored in the storage 32 (step S2).

In step S2, the processing circuit 31 performs cost calculation considering the received power in the space overlapping with the route for each of the plurality of routes from the start point to the goal point set on the map indicated by the map data, for example, and selects an optimum route from among the plurality of routes based on the result of the cost calculation. According to such step S2, for example, a shortest route is selected from the plurality of routes to avoid the space in which the propagation environment of the signal deteriorates (that is, the radio quiet zone in which the received power decreases). Note that, for example, it is considered that the decrease in the received power in the radio quiet zone is suppressed by changing the time or the frequency or by using spatial diversity. However, in the present embodiment, priority is given to more stable running (operation) of the mobile object 1 and the route that avoids the radio quiet zone is selected.

When the processing of step S2 is executed, the processing circuit 31 (control module 31e) controls the mobile object 1 to move along the route selected in step S2 (step S3). The control of the mobile object 1 in step S3 is realized by outputting the control signal for controlling the mobile object 1 generated by the processing circuit 31 to the base station 2 and transmitting the control signal from the antenna installed in the base station 2 to the mobile object 1.

Here, in a case where the processing of step S3 described above is executed, the mobile object 1 moves from the start point to the goal point along the route selected in step S2, and the mobile object 1 transmits the above-described map creation data and received power data to the information processing apparatus 3 via the base station 2 at each point while moving.

In this case, the processing circuit 31 (acquisition module 31a) included in the information processing apparatus 3 acquires, from the base station 2, the map creation data and the received power data transmitted from the mobile object 1 that moves along the route selected in step S2 (step S4).

Subsequently, the processing circuit 31 (map data creation module 31b) updates the map data stored in the storage 32 based on the map creation data acquired in step S4 (step S5). Note that, since only the map creation data on the route selected in step S2 is acquired in step S4, only a peripheral portion of the route in the map indicated by the map data is updated in step S5.

Subsequently, the processing circuit 31 (received power map creation module 31c) updates the received power map stored in the storage 32 based on the map creation data and the received power data acquired in step S4 (step S6).

Here, in step S2 described above, although the route that avoids the radio quiet zone in which the received power decreases is selected, in step S4, since only the map creation data and the received power data on the route selected in step S2 are acquired, in step S6, only the received power allocated to each position on the route of the received power map is updated.

That is, on the received power map updated in step S6 described above, it is not possible to determine whether or not the radio quiet zone (that is, radio quiet zone generated in the past) on the route along which the mobile object 1 does not move is eliminated.

Note that, although the radio quiet zone is eliminated, for example, by removing the obstacle, it is considered that the mobile object 1 in the present embodiment can detect the presence or absence of the obstacle by the LRF. However, since the LRF cannot discriminate a height of the obstacle, for example, even though the obstacle is detected by the LRF, for example, the radio quiet zone may be eliminated in a case where the height of the obstacle is low. That is, it is difficult to estimate the elimination (that is, the propagation environment of the signal in the radio quiet zone generated in the past) of the radio quiet zone by the LRF.

Thus, in the present embodiment, the processing circuit 31 (propagation environment estimation module 31d) sets, as the estimation target zone, the space (that is, the space outside the route along which the mobile object 1 moves) facing the antenna with the mobile object 1 interposed therebetween, and estimates the propagation environment (radio wave reception sensitivity) of the signal in the estimation target zone (step S7). Note that the estimation target zone corresponds to a zone (space) on a back side of the obstacle (that is, the obstacle that causes the radio quiet zone occurred in the past) disposed in the past as viewed from the mobile object 1 side moving along the route.

The processing in step S7 is executed by using the position of the mobile object 1 and the received power (that is, the received power of the signal received at the position) indicated by the received power data acquired based on the map creation data acquired in step S4 described above.

Hereinafter, a principle of estimating the propagation environment of the signal in the estimation target zone in step S9 will be described.

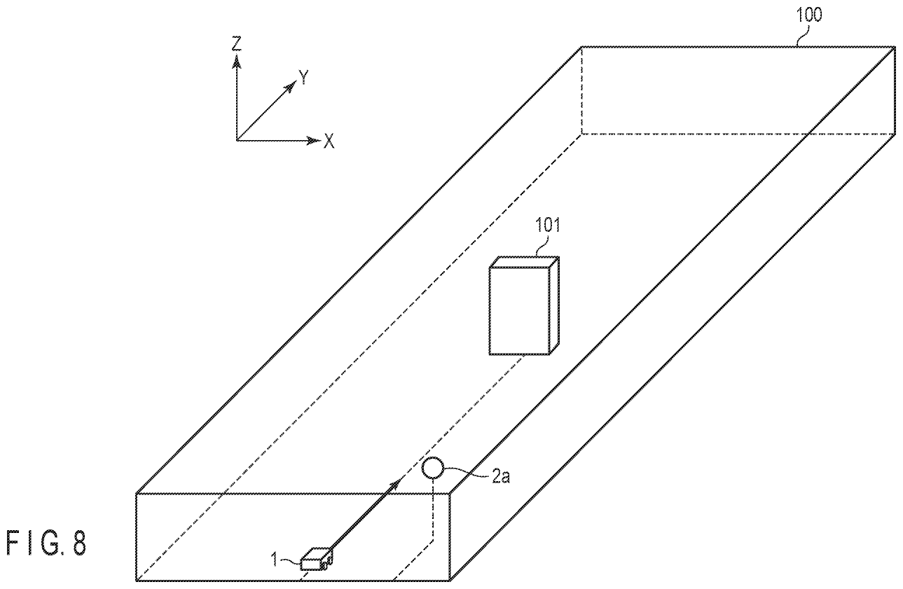

Here, it is assumed that the mobile object 1 moves in the target space as illustrated in FIG. 8. In FIG. 8, it is assumed that a target space 100 is a room of, for example, 9 m (X-axis direction)×18 m (Y-axis direction)×3 m (Z-axis direction). Note that an obstacle (radio wave shielding object) 101 of, for example, 2 m (X-axis direction)×1 m (Y-axis direction)×3 m (Z-axis direction) can be disposed in the vicinity of a center of the target space 100.

In this case, for example, the antenna 2a is disposed near a ceiling of the target space (room) 100, and the above-described received power is measured while the mobile object 1 is moved by 50 cm in the Y-axis direction along the ground of the target space 100.

Note that, in a case where the obstacle 101 is disposed, since the signal (radio wave) transmitted from the antenna 2a is shielded by the obstacle 101, the space (that is, the space on the back side of obstacle 101 as viewed from antenna 2a) facing the antenna 2a with the obstacle 101 interposed therebetween becomes the radio quiet zone.

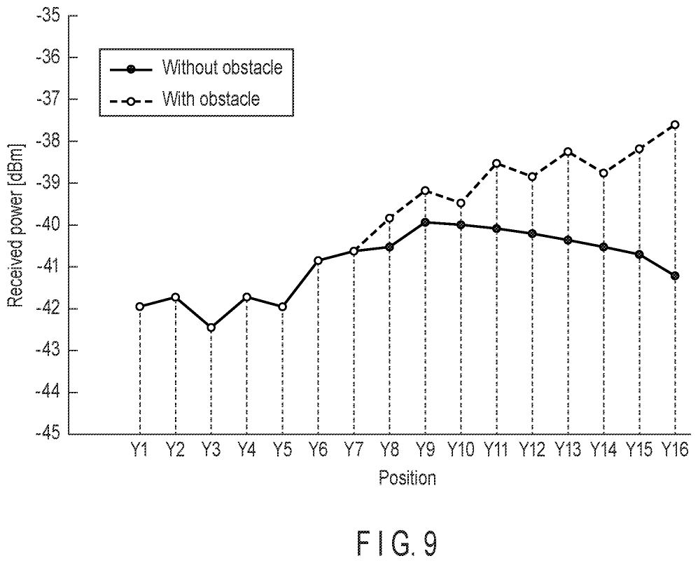

FIG. 9 illustrates an aspect in which the received power (hereinafter, referred to as a first received power) measured at each position of the mobile object 1 in a state where the above-described obstacle 101 is disposed and the received power (hereinafter, referred to as a second received power) measured at each position of the mobile object 1 in a state where the obstacle 101 is not disposed can be compared.

Note that, in FIG. 9, a horizontal axis represents a position of the mobile object 1 (reception point of the signal), and a vertical axis represents a received power measured at the position.

The position of the mobile object 1 includes positions Y1 to Y17 on a route from near an end portion of the target space 100 to approach the obstacle 101 illustrated in FIG. 8 described above. In this case, the position Y1 is a position farthest from the obstacle 101, and the position Y17 is a position closest to the obstacle 101.

In addition, the received power is, for example, a value obtained by averaging received powers (for example, RSSIs) of synchronization signals received at a plurality of frequencies (for example, 4.8 GHz, 4.825 GHz, 4.85 GHz, 4.875 GHz, and 4.9 GHz).

According to the example illustrated in FIG. 9, for example, although there is no particular difference between the first and second received powers at the positions Y1 to Y7, there is a difference between the first and second received powers at and after the position Y8. Specifically, in a case where the obstacle 101 is disposed, the mobile object 1 moving in the vicinity of the obstacle 101 directly receives the signal (synchronization signal) transmitted from the antenna 2a and further receives the reflected wave from (the surface of) the obstacle 101. Thus, the second received power is larger than the first received power in a case where the obstacle 101 is not disposed.

In the present embodiment, the propagation environment of the signal in the estimation target zone is estimated by using the tendency of the received power influenced by the obstacle 101 in the target space 100.

Referring to FIG. 8, for example, the processing circuit 31 included in the information processing apparatus 3 stores, as comparison data, data including the position (hereinafter, referred to as a first position) of the mobile object 1 when moving in a state where the obstacle 101 is disposed and the received power (first received power) of the signal received at the first position in the storage 32 in advance.

In this case, the processing circuit 31 determines whether or not there is the difference as described above with reference to FIG. 9 (that is, there is the reflected wave from the obstacle 101) by comparing the above-described comparison data with data (hereinafter, referred to as propagation environment estimation data) including the position (hereinafter, referred to as a second position) of the mobile object 1 acquired based on the map creation data acquired in step S4 and the received power (second received power) indicated by the received power data.

In a case where it is determined that there is no difference between the comparison data (the first position and the first received power) and the propagation environment estimation data (the second position and the second received power), the processing circuit 31 can estimate that the propagation environment of the signal in the estimation target zone (here, the space on the back side of the obstacle 101) does not change (that is, the obstacle 101 is disposed, and the radio quiet zone is not eliminated). Note that “there is no difference between the comparison data and the propagation environment estimation data” does not merely mean that the comparison data and the propagation environment estimation data completely match each other, and includes that the difference falls within a predetermined range. As in the present embodiment, in a case where the comparison data (the first position and the first received power) is compared with the propagation environment estimation data (the second position and the second received power), in a case where the difference between the first received power and the second received power at the same position is equal to or less than a predetermined value, it is regarded that “there is no difference between the comparison data and the propagation environment estimation data”. In addition, “the radio quiet zone is not eliminated” means that the received power of the signal received by the mobile object 1 is smaller than the predetermined received power in the estimation target zone.

Meanwhile, in a case where it is determined that there is the difference between the comparison data and the propagation environment estimation data, the processing circuit 31 can estimate that the propagation environment of the signal in the estimation target zone changes (that is, the obstacle 101 is removed and the radio quiet zone is eliminated). Note that “there is the difference between the comparison data and the propagation environment estimation data” does not simply mean that the comparison data and the propagation environment estimation data do not completely match each other, but means that the difference is outside the predetermined range. As in the present embodiment, in a case where the comparison data (the first position and the first received power) is compared with the propagation environment estimation data (the second position and the second received power), in a case where the difference between the first received power and the second received power at the same position exceeds a predetermined value, it is regarded that “there is the difference between the comparison data and the propagation environment estimation data”. In addition, “the radio quiet zone is eliminated” means that the received power of the signal received by the mobile object 1 is larger than the predetermined received power in the estimation target zone.

That is, in the present embodiment, (the change in) the propagation environment of the signal in the estimation target zone can be estimated by comparing the received powers measured at different times (timings) at the same position. Note that, although the above-described positions Y1 to Y17 are at intervals of 50 cm, for example, a position less than a position Yn (n=1, 2, . . . , 17)±25 cm is regarded as the position Yn (the same position).

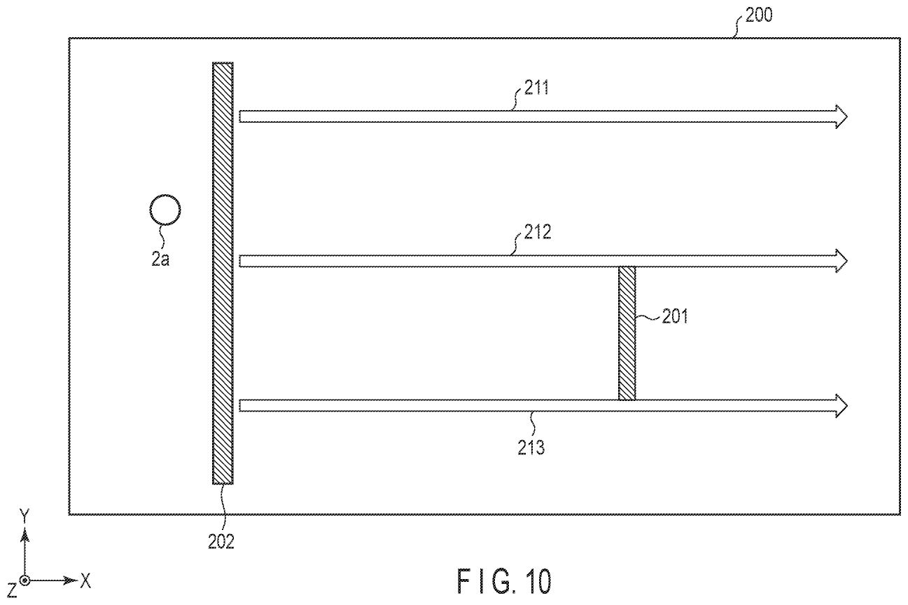

Next, it is assumed that the mobile object 1 moves in the target space as illustrated in FIG. 10. In FIG. 10, it is assumed that a target space 200 is one room (conference room) in an office environment. Note that an obstacle 201 such as a partition can be disposed in the target space 200.

In the example illustrated in FIG. 10, for example, the antenna 2a (an access point of a wireless LAN of 5 GHz band) is disposed at a position with a height of 2.25 m on a rear side of a protection barrier 202, and the mobile object 1 (terminal) that receives a beacon (control signal) moves in a space facing the antenna 2a with the protection barrier 202 interposed therebetween. Note that the access point side is a single antenna, and the mobile object 1 (terminal) side is a multi-antenna (that is, diversity is applied).

Here, it is assumed that the mobile object 1 moves along each of routes 211 to 213 extending in the X-axis direction. Note that the mobile object 1 moves at a position of 0.2 m in height at a constant speed of 0.1 m/s.

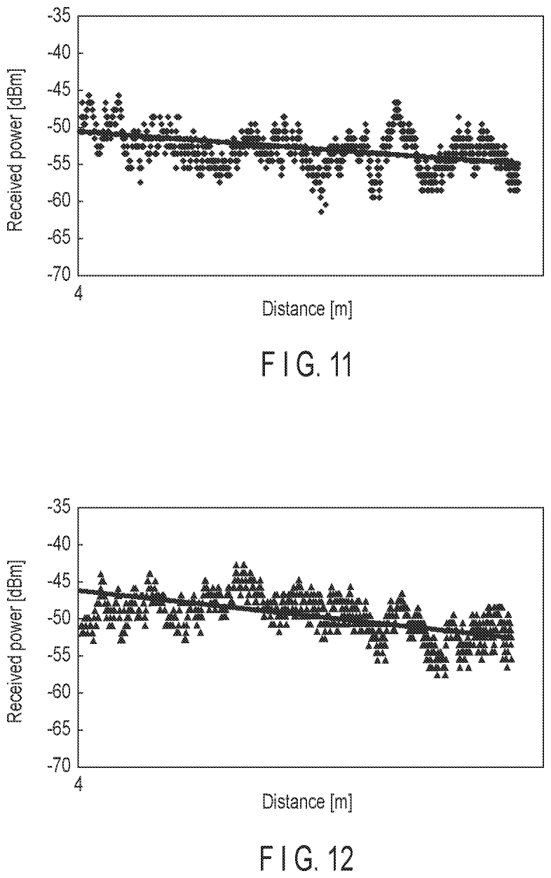

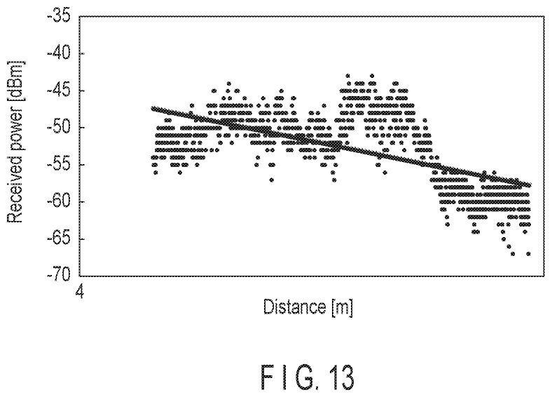

FIG. 11 illustrates an example of the received power measured at each position of the mobile object 1 moving along the route 211. FIG. 12 illustrates an example of the received power measured at each position of the mobile object 1 moving along the route 212. FIG. 13 illustrates an example of the received power measured at each position of the mobile object 1 moving along the route 213. Note that, in FIG. 9 described above, although it has been described that the horizontal axis indicates the position of the mobile object 1, in FIGS. 11 to 13, a horizontal axis indicates a distance between the mobile object 1 and the antenna 2a (access point) acquired (calculated) from the position of the mobile object 1 and the known position of the antenna 2a. In addition, FIGS. 11 to 13 also illustrate a regression line of the received power corresponding to the distance between the mobile object 1 and the antenna 2a.

First, in a case where the mobile object 1 moves along the routes 211 and 212, each position on the routes 211 and 212 is within an unobstructed view as viewed from the antenna 2a, and the above-described obstacle 201 does not influence the received power of the signal received by the mobile object 1. Thus, the received power illustrated in FIGS. 11 and 12 tends to substantially decrease (attenuate) as the distance between mobile object 1 and antenna 2a becomes longer (that is, the mobile object 1 moves away from the antenna 2a).

By contrast, in a case where the mobile object 1 moves along the route 213, each position on the route 213 until passing by the obstacle 201 is within an unobstructed view as viewed from the antenna 2a, but each position on the route 213 after passing by the obstacle 201 is out of the unobstructed view from the antenna 2a. That is, the received power illustrated in FIG. 13 greatly changes at a timing when each position is changed from the unobstructed view to the unobstructed view with the position of the obstacle 201 as a boundary. Specifically, according to FIG. 13, while the mobile object 1 is approaching the obstacle 201, the received power decreases (attenuates) as the distance between the mobile object 1 and the antenna 2a increases. However, the received power becomes large due to the influence (that is, the action of the reflected wave from the obstacle 201 in a direction in which intensities intensify each other) of the reflected wave from (the surface of) the obstacle 201 immediately before the obstacle 201 as viewed from the antenna 2a side. As a result, the signal is shielded (the unobstructed view from the antenna 2a is blocked, and direct waves do not reach) by the obstacle 201 after the position beyond the obstacle 201 as viewed from the antenna 2a side, and thus, the received power decreases rapidly.

That is, there is a difference between the received power measured at each position of the mobile object 1 moving along the routes 211 and 212 not influenced by the obstacle 201 and the received power measured at each position of the mobile object 1 moving along the route 213 influenced by the obstacle 201.

In the present embodiment, the propagation environment of the signal in the estimation target zone is estimated by using the tendency of the received power influenced by the obstacle 201 in the target space 200.

Referring to FIG. 10, for example, the processing circuit 31 included in the information processing apparatus 3 determines whether or not there is the difference as described above with reference to FIGS. 11 to 13 (that is, there is the reflected wave from the obstacle 201) by comparing the comparison data including the distance (first distance) from the antenna 2a of the mobile object 1 moving along the route 211 or 212 and the received power (first received power) of the signal received at the first distance with the propagation environment estimation data including the distance (second distance) from the antenna 2a of the mobile object 1 moving along the route 213 and the received power (second received power) of the signal received at the second distance. Note that the comparison data may be acquired based on, for example, the map creation data and the received power data transmitted from the mobile object 1 when the mobile object 1 moves along the route 211 or 212, and the propagation environment estimation data may be acquired based on, for example, the map creation data and the received power data transmitted from the mobile object 1 when the mobile object 1 moves along the route 213.

In a case where it is determined that there is the difference between the comparison data (the first distance and the first received power) and the propagation environment estimation data (the second distance and the second received power), the processing circuit 31 can estimate that the propagation environment of the signal in the estimation target zone (here, the space on the back side of the obstacle 201) does not change (that is, the obstacle 201 is disposed and the radio quiet zone is not eliminated).

Meanwhile, in a case where it is determined that there is no difference between the comparison data and the propagation environment estimation data, the processing circuit 31 can estimate that the propagation environment of the signal in the estimation target zone changes (that is, the obstacle 201 is removed and the radio quiet zone is eliminated).

That is, in the present embodiment, (the change in) the propagation environment of the signal in the estimation target zone can be estimated by comparing the received powers measured at the positions (that is, different positions) at an identical distance from the antenna 2a.

Note that, for example, although FIG. 13 illustrates the received power measured at the position beyond the obstacle 201, since there is a difference based on a phenomenon that the received power becomes large immediately before the obstacle 201 in a case where the obstacle 201 is disposed as described above, it is not necessary to measure the received power by moving the mobile object 1 to the position (that is, the radio quiet zone) beyond the obstacle 201 in order to acquire the above-described propagation environment estimation data.

As described above, in step S7 illustrated in FIG. 7, focusing on the fact that the received power becomes large (increases) due to the reflected wave from the surface of the obstacle (radio wave shielding object), the comparison data is compared with the propagation environment estimation data, and thus, the propagation environment of the signal in the estimation target zone (that is, the space corresponding to the back side of the obstacle) facing the antenna with the mobile object 1 interposed therebetween is estimated.

When the processing of step S7 is executed, the processing circuit 31 (received power map creation module 31c) reflects the result of the processing of step S7 (that is, the estimation result of the propagation environment) in the received power map (step S8). Specifically, in step S8, as described above, in a case where it is estimated in step S7 that the propagation environment of the signal in the estimation target zone is improved (that is, the radio quiet zone is eliminated), processing of reflecting the elimination of the radio quiet zone in the received power map (that is, updating the received power map to increase the received power allocated to the radio quiet zone) is executed.

When the processing of step S8 described above is executed, the processing returns to step S2 and the processing is repeated. Accordingly, for example, in a case where the radio quiet zone is generated on the received power map updated in step S6 by newly arranging the obstacle, the route that avoids the radio quiet zone is selected in step S2 that is repeatedly executed. In addition, in step S2 described above, the route that avoids the radio quiet zone is selected, but in a case where the radio quiet zone is eliminated (that is, the elimination of the radio quiet zone is reflected in the received power map), in step S2 that is repeatedly executed, the route that passes through the space that is the radio quiet zone can be selected.

Note that, in FIG. 7, for example, although the situation in which the mobile object 1 repeatedly moves along the route from the start point to the goal point set on the map indicated by the map data is assumed, the processing illustrated in FIG. 7 may be ended, for example, at a timing when the predetermined control of the mobile object 1 (that is, for example, the conveyance of the package by the mobile object 1 or the like) is ended.

In addition, in the processing illustrated in FIG. 7, although it has been described that the estimation result of the propagation environment in the estimation target zone in step S7 is used for the control (selection of the route) of the mobile object 1, the estimation result may be used for other processing, or may be output from the information processing apparatus 3 to an external apparatus in order to be used for processing executed in the external apparatus.

Hereinafter, a specific example of an operation of the information processing apparatus 3 according to the present embodiment will be described by using the above-described examples illustrated in FIGS. 2 and 3.

First, the map data indicating the map illustrated in FIG. 2 is created by moving the mobile object 1 in the target space. In addition, although not illustrated, the received power map in which the received power measured at each position on the map indicated by the map data is allocated to the position is created. Note that the radio quiet zone (the space in which the propagation environment of the signal deteriorates) in which the received power decreases is not generated on the received power map created herein.

Next, the route along which the mobile object 1 moves is selected based on the above-described map data and received power map. Here, the route 1d illustrated in FIG. 2 is selected.

In a case where the route 1d is selected as described above, the mobile object 1 is controlled to move from the start point 1b to the goal point 1c along the route 1d (to carry the package).

Note that the mobile object 1 transmits the map creation data and the received power data at each position on the route 1d while moving along the route 1d. In this case, the map data and the received power map are updated based on the map creation data and the received power data transmitted from the mobile object 1.

Here, the obstacle 1g is disposed in the target space as illustrated in FIG. 3 while the mobile object 1 is moving along the route 1d. In this case, the radio quiet zone 1h is generated, and the received power map is updated by allocating the decreased received power to the position overlapping with the radio quiet zone 1h.

According to such a received power map, the route 1f that avoids the radio quiet zone 1h is selected as the route along which the mobile object 1 moves, and the mobile object 1 is controlled to move from the start point 1b to the goal point 1c along the route 1f.

Note that the mobile object 1 transmits the map creation data and the received power data at each position on the route 1f while moving along the route 1f. In this case, the map data and the received power map are updated based on the map creation data and the received power data transmitted from the mobile object 1.

Furthermore, the propagation environment of the signal in the estimation target zone (the space facing the antenna 2a with the mobile object 1 interposed therebetween) is estimated by comparing the comparison data prepared in advance with the propagation environment estimation data (that is, the propagation environment estimation data including the position of the mobile object 1 and the received power measured at the position) acquired based on the map creation data and the received power data transmitted at each position on the route 1f as described above.

In this case, for example, the received power measured when the mobile object 1 passes between the obstacle 1g and the antenna 2a (that is, the antenna 2a is in front of the obstacle 1g) in a state where the obstacle 1g is not removed becomes large due to the influence of the reflected wave from the obstacle 1g. The presence or absence of such a reflected wave is determined by comparing the above-described comparison data with the propagation environment estimation data. In a case where it is determined that there is the reflected wave, it can be estimated that the obstacle 1g is disposed and the radio quiet zone 1h on a far side of the obstacle 1g is not eliminated (that is, the received power of the signal is smaller than the predetermined received power). Meanwhile, in a case where it is determined that there is no reflected wave, it can be estimated that the obstacle 1g is not disposed (already removed) and the radio quiet zone 1h on the far side of the position where the obstacle 1g is disposed is eliminated (that is, the received power of the signal is larger than the predetermined received power).

Note that the comparison data is, for example, data including each position on the route 1f and the received power measured at the position in a state where the obstacle 1g is disposed or in a state where the obstacle 1g is not disposed, but may be any data as long as it is possible to determine whether or not there is the reflected wave from the above-described obstacle 1g. That is, the comparison data may be data including each position on a route other than the route 1f and the received power measured at the position, or may be data (sample data) prepared in advance before the mobile object 1 moves in the target space.

In a case where it is estimated that the radio quiet zone 1h is eliminated as described above, the received power map is updated to increase the received power allocated to the radio quiet zone 1h (that is, the estimation result is reflected in the received power map). According to such a received power map, it is possible to select the route 1d again instead of the route 1f and move the mobile object 1 along the shortest route (that is, the route passing through the space 1h).

As described above, in the present embodiment, the propagation environment of the signal in the space (that is, the space on the far side of the mobile object 1 as viewed from the antenna) facing the antenna that transmits first and second signals with the mobile object 1 interposed therebetween by acquiring the comparison data (first data) including the first position of the mobile object 1 at a time of receiving the first signal and the first received power of the first signal, acquiring the propagation environment estimation data (second data) including the second position of the mobile object 1 at a time of receiving the second signal different from the first signal and the second received power of the second signal, and comparing the comparison data with the propagation environment estimation data. Note that the above-described comparison data may be stored in, for example, the storage 32.

That is, in the present embodiment, in a case where the mobile object 1 moves in the space in which the arrangement of obstacles (for example, a package such as a cardboard box) changes with the lapse of time, the propagation environment of the signal in the space on the far side of the mobile object 1 (that is, the estimation target zone) as viewed from the antenna is estimated from a relationship between the position of the mobile object 1 (mobile radio device) obtained by utilizing the wireless communication and the received power of the signal received at the position (that is, the presence or absence of the obstacle which is the radio wave shielding object is detected).

In the present embodiment, with the above-described configuration, it is possible to efficiently grasp the propagation environment of the signal.

Specifically, according to the present embodiment, under a situation in which the route that avoids the radio quiet zone is selected and the mobile object 1 is controlled when the radio quiet zone is generated, it is possible to estimate the propagation environment of the signal in the estimation target zone corresponding to the radio quiet zone based on the received power measured at the position (that is, the environment in which the obstacle is not disposed between each of the first and second positions and the antenna) where the obstacle is not disposed between the antenna and the mobile object without moving the mobile object 1 to the radio quiet zone. That is, in the present embodiment, the mobile object 1 may move in the space within the unobstructed view as viewed from the antenna, and for example, it is possible to avoid a situation in which the mobile object 1 does not normally operate by moving the mobile object 1 to the radio quiet zone in order to grasp the propagation environment of the signal.

Note that, in the present embodiment, the control signal for controlling the mobile object 1 is output based on the propagation environment estimated as described above. Specifically, the received power map (first map) obtained by mapping the above-described first position and first received power is created, the received power map is updated (that is, the first map is updated to the second map) based on the second position, the second received power, and the estimated propagation environment, and the mobile object 1 is controlled based on the updated received power map (second map) (the route along which the mobile object 1 moves is selected).

Accordingly, it is possible to avoid the space in which the propagation environment of the signal deteriorates and to select the route along which the route passes through the space in which the propagation environment of the signal is improved, and thus, it is possible to realize efficient control of the mobile object 1 (conveyance of the package).

Note that, in the present embodiment, although the received power map created by allocating the received power measured at the position (the received power of the signal received at the position) to the position of the mobile object 1 has been mainly described, the received power map may be data obtained by further mapping the obstacle detected by measuring the TOF by the LRF or the like as described above. In addition, the map data and the received power map in the present embodiment may be output (displayed) to be referred to by, for example, an administrator who manages the mobile object 1, the information processing apparatus 3, and the like.

In addition, the comparison data in the present embodiment includes the first received power of the first signal received by the mobile object 1 at the first position at a first time, and the propagation environment estimation data includes the second received power of the second signal received by the mobile object 1 at a second position identical to the first position at a second time different from the first time. That is, the comparison data and the propagation environment estimation data in the present embodiment may be data including received powers measured at the identical position and at different times as described above with reference to FIGS. 8 and 9. Note that, in the present embodiment, “the second position identical to the first position” includes that the difference between the first position and the second position is less than a predetermined position.

However, the comparison data and the propagation environment estimation data may be data including received powers measured at different positions as described above with reference to FIGS. 10 to 13. Furthermore, in order to use distance attenuation characteristics of the signal (radio wave), the comparison data and the propagation environment estimation data may be data including the distance (first and second distances) between the mobile object 1 and the antenna acquired based on the position of the mobile object 1 (and the antenna) instead of the position of the mobile object 1 (first and second positions).

The comparison data in the present embodiment may be any data prepared from the viewpoint that it is possible to easily detect that the obstacle (radio wave shielding object) is disposed or that the obstacle is removed (that is, the propagation environment of the signal in the estimation target zone is easily estimated) by comparison with the propagation environment estimation data.

Note that, in the present embodiment, it is determined whether or not the reflected wave from the obstacle disposed in the target space (that is, the change in the received power due to the reflected wave) by comparing the comparison data with the propagation environment estimation data, and the propagation environment of the signal in the estimation target zone is estimated based on the determination result.

Here, for example, the cardboard box or the like is assumed as the obstacle in the present embodiment, but a physical obstacle and an obstacle to a signal (radio wave) are different. For example, when an object packed in the cardboard box as the obstacle is plastic or the like, a signal is not shielded by the obstacle, and the radio quiet zone is not generated. Meanwhile, when the object packed in the cardboard box as the obstacle is metal or the like (radio wave shielding object), a signal is shielded by the obstacle, and the radio quiet zone is generated.

In the present embodiment, since the propagation environment of the signal in the estimation target zone is estimated based on the determination result of whether or not there is the reflected wave from the obstacle as described above, it is possible to estimate the propagation environment of the signal in the estimation target zone in consideration of, for example, whether or not the obstacle is the radio wave shielding object, and it can be said that the specificity of the phenomenon influencing the propagation environment is high. That is, in the present embodiment, in a case where there is the reflected wave, since the obstacle is the radio wave shielding object, it can be estimated that the propagation environment of the signal on the back side of the obstacle viewed from the antenna deteriorates. Meanwhile, in a case where there is no reflected wave even though the obstacle is disposed, since there is no radio wave shielding object, it can be estimated that the propagation environment of the signal on the back side of the obstacle as viewed from the antenna does not deteriorate (that is, is good). Note that, in the present embodiment, it is assumed that the situation of the obstacle (stacked packages) varies with the lapse of time in the environment in which the plurality of obstacles can be arranged in the target space. However, according to a temporally different received power map reflecting the estimation result of the propagation environment of the signal in the above-described estimation target zone, it is possible to grasp an obstacle that can be the radio wave shielding object without requiring other information on the obstacle.

Furthermore, the generation or elimination of the radio quiet zone depends on the height of the obstacle (radio wave shielding object). It is considered that the influence of the reflected wave from the obstacle on the received power is small in a case where the height of the obstacle is low, and the influence of the reflected wave from the obstacle on the received power is large in a case where the height of the obstacle is high. Thus, in the present embodiment, the propagation environment of the signal in the estimation target zone can be estimated in consideration of the height of the obstacle by using a degree of difference (that is, the magnitude of the influence of the reflected wave from the obstacle on the received power) between the above-described comparison data and propagation environment estimation data.

In addition, in the present embodiment, it is possible to detect the obstacle disposed in the target space (measure the distance to the obstacle) by measuring the TOF by, for example, LRF or the like. Whether or not the obstacle detected in this manner is the radio wave shielding object is unknown, but the processing of estimating the propagation environment of the signal in the estimation target zone may be executed (that is, the propagation environment is estimated based on the obstacle disposed in the target space) only in a case where the mobile object 1 moves in the vicinity of the detected obstacle. According to such a configuration, it is possible to reduce a load of the processing of estimating the propagation environment of the signal in the estimation target zone.

Note that the present embodiment relates to a technique for indirectly estimating the propagation environment of the signal in the space (radio quiet zone) in which the received power decreases. However, in the present embodiment, in the environment in which the plurality of mobile objects 1 (for example, AMRs) move in the target space, in a case where there is a possibility that the received power decreases on the back side of the obstacle (radio wave shielding object), the plurality of mobile objects 1 may be operated in cooperation. For example, when a first mobile object 1 moves in the space in which the received power may decrease, a second mobile object 1 may assist the operation of the first mobile object 1 by moving the second mobile object 1 in a space within an unobstructed view as viewed from the first mobile object 1.

In addition, in the present embodiment, although it has been described that the route that avoids the radio quiet zone is selected in a case where the radio quiet zone is generated due to the arrangement of obstacles (radio wave shielding object), a mechanism for improving the propagation environment of the signal in the radio quiet zone may be combined with the present embodiment. For example, in a case where it is possible to utilize greatly different frequency bands such as 900 MHz and 5 GHz, when the obstacle (radio wave shielding object) is detected, the frequency band may be switched (for example, a frequency band of 5 GHz is switched to a frequency band of 900 MHz) to cause the radio wave to go around, and the decrease in the received power on the back side of the obstacle may be eliminated.

Note that, in the present embodiment, although it has been described that the processing circuit 31 included in the information processing apparatus 3 includes the modules 31a to 31f, some of the modules 31a to 31f may be arranged outside the processing circuit 31.

Furthermore, some of the modules 31a to 31f included in the processing circuit 31 may be omitted. Specifically, the information processing apparatus 3 according to the present embodiment may be configured to estimate at least the propagation environment of the signal in the estimation target zone, and for example, a configuration for controlling the mobile object 1 (for example, the control module 31e) may be omitted.

In addition, in the present embodiment, although it has been described that the information processing apparatus 3 is one apparatus, the information processing apparatus 3 may be realized by a plurality of apparatuses.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

With regard to the above-described embodiments, the following supplementary notes are further disclosed.

(1)
An information processing apparatus including:
a processing circuit configured to:
acquire first data that includes:
a first position of a mobile object at a time of receiving a first signal transmitted from an antenna or a first distance between the mobile object and the antenna, and
a first received power of the first signal;
acquire second data that includes:
a second position of the mobile object at a time of receiving a second signal different from the first signal transmitted from the antenna or a second distance between the mobile object and the antenna, and
a second received power of the second signal; and estimate a propagation environment of a signal in a space facing the antenna with the second position interposed therebetween by comparing the first data with the second data.
   (2)
   The information processing apparatus according to (1), wherein the processing circuit is configured to output a control signal for controlling the mobile object based on the estimated propagation environment.
   (3)
   The information processing apparatus according to (2), wherein
the processing circuit is configured to:
create a first map obtained by mapping the first position and the first received power;
update the first map to a second map based on the second position, the second received power, and the estimated propagation environment; and
control the mobile object based on the second map.
   (4)
   The information processing apparatus according to any one of (1) to (3), wherein
the first received power is influenced by an object disposed between the first position and a space in which the propagation environment of the signal is estimated, and
the processing circuit is configured to:
estimate that a received power of a signal received by the mobile object is smaller than a predetermined received power in the space in a case where a difference between the first data and the second data is in a predetermined range; and
estimate that the received power of the signal received by the mobile object is larger than the predetermined received power in the space in a case where the difference between the first data and the second data is out of the predetermined range.
   (5)
   The information processing apparatus according to (4), wherein
the processing circuit is configured to:
control the mobile object to move along a route that avoids the space in a case where the received power of the signal received by the mobile object is estimated to be smaller than the predetermined received power in the space, and
control the mobile object to move along a route that passes through the space in a case where the received power of the signal received by the mobile object is estimated to be larger than the predetermined received power in the space.
   (6)
   The information processing apparatus according to any one of (1) to (5), further including
storage configured to store the first data,
wherein the processing circuit is configured to estimate the propagation environment by comparing the first data stored in the storage with the second data in a case where the second data is acquired.
   (7)
   The information processing apparatus according to any one of (1) to (6), wherein an object configured to shield a signal is not disposed between each of the first and second positions and the antenna.
   (8)
   The information processing apparatus according to any one of (1) to (7), wherein
the first data includes a first received power of a first signal received by the mobile object at the first position at a first time,
the second data includes a second received power of a second signal received by the mobile object at a second position at a second time different from the first time, and
the first position and the second position are the same position.
   (9)
   The information processing apparatus according to any one of (1) to (8), wherein the processing circuit is configured to determine whether or not there is a reflected wave from an object disposed in a space in which the mobile object moves by comparing the first data with the second data, and estimate the propagation environment based on the determination result.
   (10)
   The information processing apparatus according to any one of (1) to (9), wherein
the mobile object is configured to detect an object disposed in a space in which the mobile object moves, and
the processing circuit is configured to estimate the propagation environment based on the detected object.
   (11)
   The information processing apparatus according to (10), wherein the object is detected based on reflection of a laser emitted from the mobile object.
   (12)
   The information processing apparatus according to any one of (1) to (11), wherein a space in which the propagation environment of the signal is estimated includes a space in which a received power of the signal is smaller than a predetermined received power.
   (13)
   The information processing apparatus according to any one of (1) to (12), wherein the first received power is influenced by an object disposed between the first position and a space in which the propagation environment of the signal is estimated.
   (14)
   A system including:
the information processing apparatus according to any one of (1) to (13); and
a mobile object connected to the information processing apparatus to be able to communicate.
   (15)
   A method including:
acquiring first data that includes:
a first position of a mobile object at a time of receiving a first signal transmitted from an antenna or a first distance between the mobile object and the antenna, and
a first received power of the first signal;
acquiring second data that includes:
a second position of the mobile object at a time of receiving a second signal different from the first signal transmitted from the antenna or a second distance between the mobile object and the antenna, and a second received power of the second signal; and
estimating a propagation environment of a signal in a space facing the antenna with the second position interposed therebetween by comparing the first data with the second data.
   (16)
   A non-transitory computer-readable storage medium having stored thereon a program which is executed by a computer of an information processing apparatus, the program including instructions capable of causing the computer to execute functions of:
   acquiring first data that includes:
   a first position of a mobile object at a time of receiving a first signal transmitted from an antenna or a first distance between the mobile object and the antenna, and
   a first received power of the first signal;
   acquiring second data that includes:
   a second position of the mobile object at a time of receiving a second signal different from the first signal transmitted from the antenna or a second distance between the mobile object and the antenna, and a second received power of the second signal; and
   estimating a propagation environment of a signal in a space facing the antenna with the second position interposed therebetween by comparing the first data with the second data.

What is claimed is:

1. An information processing apparatus comprising:
a processing circuit configured to:
acquire first data that includes:
a first position of a mobile object at a time of receiving a first signal transmitted from an antenna or a first distance between the mobile object and the antenna, and
a first received power of the first signal;
acquire second data that includes:
a second position of the mobile object at a time of receiving a second signal different from the first signal transmitted from the antenna or a second distance between the mobile object and the antenna, and
a second received power of the second signal; and
estimate a propagation environment of a signal in a space facing the antenna with the second position interposed therebetween by comparing the first data with the second data.

2. The information processing apparatus according to claim 1, wherein the processing circuit is configured to output a control signal for controlling the mobile object based on the estimated propagation environment.

3. The information processing apparatus according to claim 2, wherein
the processing circuit is configured to:
create a first map obtained by mapping the first position and the first received power;
update the first map to a second map based on the second position, the second received power, and the estimated propagation environment; and
control the mobile object based on the second map.

4. The information processing apparatus according to claim 1, wherein
the first received power is influenced by an object disposed between the first position and a space in which the propagation environment of the signal is estimated, and
the processing circuit is configured to:
estimate that a received power of a signal received by the mobile object is smaller than a predetermined received power in the space in a case where a difference between the first data and the second data is in a predetermined range; and
estimate that the received power of the signal received by the mobile object is larger than the predetermined received power in the space in a case where the difference between the first data and the second data is out of the predetermined range.

5. The information processing apparatus according to claim 4, wherein
the processing circuit is configured to:
control the mobile object to move along a route that avoids the space in a case where the received power of the signal received by the mobile object is estimated to be smaller than the predetermined received power in the space, and
control the mobile object to move along a route that passes through the space in a case where the received power of the signal received by the mobile object is estimated to be larger than the predetermined received power in the space.

6. The information processing apparatus according to claim 1, further comprising
storage configured to store the first data,
wherein the processing circuit is configured to estimate the propagation environment by comparing the first data stored in the storage with the second data in a case where the second data is acquired.

7. The information processing apparatus according to claim 1, wherein an object configured to shield a signal is not disposed between each of the first and second positions and the antenna.

8. The information processing apparatus according to claim 1, wherein
the first data includes a first received power of a first signal received by the mobile object at the first position at a first time,
the second data includes a second received power of a second signal received by the mobile object at a second position at a second time different from the first time, and
the first position and the second position are the same position.

9. The information processing apparatus according to claim 1, wherein the processing circuit is configured to determine whether or not there is a reflected wave from an object disposed in a space in which the mobile object moves by comparing the first data with the second data, and estimate the propagation environment based on the determination result.

10. The information processing apparatus according to claim 1, wherein
the mobile object is configured to detect an object disposed in a space in which the mobile object moves, and
the processing circuit is configured to estimate the propagation environment based on the detected object.

11. The information processing apparatus according to claim 10, wherein the object is detected based on reflection of a laser emitted from the mobile object.

12. The information processing apparatus according to claim 1, wherein a space in which the propagation environment of the signal is estimated includes a space in which a received power of the signal is smaller than a predetermined received power.

13. The information processing apparatus according to claim 1, wherein the first received power is influenced by an object disposed between the first position and a space in which the propagation environment of the signal is estimated.

14. A system comprising:
the information processing apparatus according to claim 1; and
a mobile object connected to the information processing apparatus to be able to communicate.

15. A method comprising:
acquiring first data that includes:
a first position of a mobile object at a time of receiving a first signal transmitted from an antenna or a first distance between the mobile object and the antenna, and
a first received power of the first signal;
acquiring second data that includes:
a second position of the mobile object at a time of receiving a second signal different from the first signal transmitted from the antenna or a second distance between the mobile object and the antenna, and
a second received power of the second signal; and
estimating a propagation environment of a signal in a space facing the antenna with the second position interposed therebetween by comparing the first data with the second data.

16. A non-transitory computer-readable storage medium having stored thereon a program which is executed by a computer of an information processing apparatus, the program comprising instructions capable of causing the computer to execute functions of:
acquiring first data that includes:
a first position of a mobile object at a time of receiving a first signal transmitted from an antenna or a first distance between the mobile object and the antenna, and
a first received power of the first signal;
acquiring second data that includes:
a second position of the mobile object at a time of receiving a second signal different from the first signal transmitted from the antenna or a second distance between the mobile object and the antenna, and
a second received power of the second signal; and
estimating a propagation environment of a signal in a space facing the antenna with the second position interposed therebetween by comparing the first data with the second data.
